(19) United States
(12) Patent Application Publication
(10) Pub. No.: US 2004/0076561 A1
(43) Pub. Date: Apr. 22, 2004

(54) Method for producing hydrogen storage material and hydrogen storing and desorbing apparatus

(76) Inventors: Hisashi Kajiura, Kanagawa (JP); Masashi Shiraishi, Tokyo (JP); Eisuke Negishi, Tokyo (JP); Masafumi Ata, Kanagawa (JP); Atsuo Yamada, Kanagawa (JP)

Correspondence Address: BELL, BOYD & LLOYD, LLC, P. O. BOX 1135, CHICAGO, IL, 60690-1135, US

(21) Appl. No.: 10/276,172

(22) PCT Filed: May 23, 2001
(86) PCT No.: PCT/JP01/04333

(30) Foreign Application Priority Data
May 23, 2000 (JP) 2000-151200

(51) Int. Cl. B01J 20/20; F17C 11/00

(52) U.S. Cl. 422/187; 422/190; 422/211; 422/198; 422/242; 502/439

(57) ABSTRACT

A hydrogen storing and desorbing apparatus is adapted to store hydrogen by a hydrogen storage material and desorb the stored hydrogen from a hydrogen storage material. The hydrogen storing and desorbing apparatus comprises a pressure-proof vessel (2), a cartridge (3) having an outside diameter smaller than the inside diameter of the pressure-proof vessel and an outer peripheral wall part (3a) and a bottom wall part (3b) made of a porous material and capable of providing a carbonaceous material therein, legs (6) for holding the cartridge (3) in the pressure-proof vessel (2) so that the bottom wall part is spaced from the bottom surface (2b) of the pressure-proof vessel (2) and the outer peripheral wall part is spaced from the inner side surface (2a) of the pressure-proof vessel (2), gas passages (11a) and (11b) connected to the pressure-proof vessel (2), valves (12a) and (12b) provided in the gas passages and a hydrogen gas supply source (14) connected to the pressure-proof vessel (2) by the gas passage.

### TECHNICAL FIELD

The present invention relates to a method for producing a hydrogen storage material and a hydrogen storing and desorbing apparatus, and more particularly to a method for producing a hydrogen storage material by which a large amount of hydrogen can be efficiently stored and a hydrogen storing and desorbing apparatus by which a large amount of hydrogen can be efficiently stored to a hydrogen storage material and hydrogen can be efficiently desorbed from a hydrogen storage material which stores the hydrogen.

### BACKGROUND ART

There has been hitherto widely employed fossil fuel such as gasoline, gas oil, etc. as the energy source for producing an electric power as well as the energy source of motor vehicles or the like. The use of the fossil fuel allows human beings to enjoy the rapid and active improvement of living standard or the development of industries, etc., however, the earth is opened to the menace of a serious environmental destruction. Further, a serious situation occurs that the fossil fuel may be possibly exhausted and there is some doubt about a stable supply of the fossil fuel for a long period.

Thus, recently, hydrogen has been greatly paid attention to as a clean and inexhaustible energy source in place of the fossil fuel because of reasons that the hydrogen is contained in water, inexhaustibly exists on the earth and includes a large quantity of chemical energy per amount of material and further, the hydrogen does not discharge harmful substances or global greenhouse gas or the like when it is used as the energy source.

Especially recently, an electric energy generator that an electric energy can be taken out from the hydrogen energy has been eagerly studied and developed and it has been expected that the electric energy generator is applied to a large-scale power generation, an onsite private power generation, and further, to a power supply for a motor vehicle.

On the other hand, since the hydrogen is gaseous under ambient temperature and ambient pressure, it is treated with more difficulty than liquid or solid. Since the density of the gas is extremely small as compared with that of liquid or solid, the chemical energy of the gas is small per volume. Further, it is inconveniently difficult to store or transport the gas. Still further, since the hydrogen is gas, it is liable to leak. When the hydrogen leaks, the danger of explosion is undesirably generated, which results in a great difficulty in utilization of the hydrogen energy.

Thus, in order to put an energy system using the hydrogen energy to practical use, the development of a technique that the gaseous hydrogen is efficiently and safely stored in a small volume has been promoted. There have been proposed a method for storing the hydrogen as high pressure gas, a method for storing the hydrogen as liquefied hydrogen and a method for using a hydrogen storage material, or the like.

In the method for storing the hydrogen as the high pressure gas, since a very strong metallic pressure-proof vessel such as a bomb needs to be used as a storage vessel, the vessel itself becomes extremely heavy and the density of the high pressure gas is ordinarily about 12 mg/cc. Accordingly, not only the storage density of the hydrogen is disadvantageously terribly small and a storing efficiency is low, but also there is a problem in view of safety because of high pressure.

On the contrary, in the method for storing the hydrogen as the liquefied hydrogen, the storage density of the hydrogen is ordinarily about 70 mg/cc. While the storage density of the hydrogen is considerably high, it is necessary to cool hydrogen to −250° C. or lower in order to liquefy the hydrogen, so that an additional device such as a cooling device is required. Therefore, not only a system has been undesirably complicated, but also energy for cooling has been needed.

Further, hydrogen storage alloys are the most effective materials among the hydrogen storage materials. For instance, there have been known lanthanum-nickel, vanadium, and magnesium hydrogen storage alloys. The practical hydrogen storage density of these hydrogen storage alloys is generally about 100 mg/cc. Although the hydrogen is stored in other materials, the hydrogen storage density is not lower than the density of the liquefied hydrogen. Therefore, the use of the hydrogen storage material is the most efficient among the conventional hydrogen storing methods. Further, when the hydrogen storage alloy is used, the hydrogen can be stored to the hydrogen storage alloy and the hydrogen can be desorbed from the hydrogen storage alloy at the level of room temperature. Further, since the hydrogen storage state is controlled under the balance of the partial pressure of hydrogen, the hydrogen storage alloy is advantageously treated more easily than the high pressure gas or the liquefied hydrogen.

However, since the component material of the hydrogen storage alloy is a metallic alloy, the hydrogen storage alloy is heavy and the amount of stored hydrogen is limited to approximately 20 mg/g per unit weight, which may not be said to be sufficient. Further, the structure of the hydrogen storage alloy is gradually broken in accordance with the repeated storing and desorbing of hydrogen gas so that a performance is undesirably deteriorated. Still further, there may be possibly generated fears of the problems of resources and an environment depending on the composition of the alloy.

Thus, for overcoming the above described problems of the conventional methods for storing hydrogen, a carbonaceous material is paid attention to as the hydrogen storage material and studied from all angles. For example, Japanese Patent Application Laid-Open No. hei. 5-270801 proposes a method that hydrogen is added to react with fullerene to store hydrogen. In this method, since chemical bonds such as covalent bonds are formed between carbon atoms and hydrogen atoms, this method is to be called an addition of hydrogen rather than a storing of hydrogen. Since the upper limit of the amount of hydrogen which can be added by the chemical bonds is essentially restricted to the number of unsaturated bonds of carbon atoms, the amount of stored hydrogen is limited.

Further, Japanese Patent Application Laid-Open No. hei. 10-72291 proposes a technique that fullerene is used as the hydrogen storage material and the surface of fullerene is covered with catalytic metal such as platinum by a vacuum deposition method or a sputtering method to store hydrogen. In order to employ platinum as the catalytic metal and cover the surface of fullerene with it, much platinum needs to be used so that not only a cost is increased, but also a problem is generated in view of resources.

It has been heretofore difficult to say that the conventionally known methods for storing hydrogen are practical when hydrogen energy is utilized. Especially, when the hydrogen energy is employed as an energy source for motor vehicles, marine vessels, general domestic power supplies, various kinds of small electric devices, etc., or when a large amount of hydrogen needs to be conveyed, the conventional methods for storing hydrogen are not practical.

Further, when hydrogen is stored to the carbonaceous material and hydrogen stored to the carbonaceous material is desorbed therefrom, since the carbonaceous material has been hitherto simply provided in a pressure-proof vessel, hydrogen has been supplied to the pressure-proof vessel and the pressure-proof vessel has been closed and held for a prescribed time to store hydrogen to the carbonaceous material, and the pressure-proof vessel has been opened as required to desorb the hydrogen stored to the carbonaceous material. Accordingly, a large amount of hydrogen cannot be efficiently stored to the carbonaceous material.

### DISCLOSURE OF THE INVENTION

The present invention is proposed by taking the above described circumstances into consideration and it is an object of the present invention is to provide a method for producing a hydrogen storage material by which a large amount of hydrogen can be efficiently stored and a hydrogen storing and desorbing apparatus by which a large amount of hydrogen can be efficiently stored to a hydrogen storage material and hydrogen can be efficiently desorbed from a hydrogen storage material which stores hydrogen.

In order to achieve the above described object, a proposed method for storing hydrogen according to the present invention comprises the steps of: providing a carbonaceous material in a cartridge whose outer peripheral wall part and bottom wall part are made of a porous material; then, arranging and providing the cartridge in a pressure-proof vessel having an inside diameter larger than the outside diameter of the cartridge so that the bottom wall part of the cartridge is spaced from the bottom surface of the pressure-proof vessel and the outer peripheral wall part of the cartridge is spaced from the inner side surface of the pressure-proof vessel; and supplying hydrogen to the pressure-proof vessel, sealing the pressure-proof vessel and holding the vessel for a prescribed time.

In the method for storing hydrogen according to the present invention, since the carbonaceous material is provided in the cartridge whose outer peripheral wall part and bottom wall part are made of a porous material and the cartridge is arranged and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, hydrogen is supplied to the pressure-proof vessel under this state, and the pressure-proof vessel is sealed and held for a prescribed time, the hydrogen is stored to the carbonaceous material through the outer peripheral wall part and the bottom wall part of the cartridge made of the porous material. Therefore, there is generated a large area where the hydrogen can come into contact with the carbonaceous material, so that a large amount of hydrogen can be efficiently stored to the carbonaceous material.

The cross-section of the cartridge used here is desirably annular shape and its inner peripheral wall part is desirably made of a porous material. Since the cross-section of the cartridge is annular shape and its inner peripheral wall part is made of the porous material, the hydrogen is stored to the carbonaceous material through the outer peripheral wall part, the inner peripheral wall part and the bottom wall part of the cartridge made of the porous material, so that the hydrogen can come into contact with carbonaceous material in a larger area and a large amount of hydrogen can be efficiently stored to the carbonaceous material.

Since the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the gas including hydrogen gas and substantially including no reactive gas as impurity gas is introduced to the pressure-proof vessel, and the pressure-proof vessel is sealed, heated and held for a prescribed time, hydrogen is stored to the carbonaceous material.

In the present invention, the gas including hydrogen gas and substantially including no reactive gas as impurity gas is introduced to the pressure-proof vessel, so that the surface of the carbonaceous material can be cleaned and hydrogen can be stored to the carbonaceous material in the same gas atmosphere.

In the present invention, the pressure-proof vessel is preferably heated to 50° C. or higher.

In the present invention, the gas including hydrogen gas and substantially including no reactive gas as impurity gas is preferably supplied to hold the pressure of the pressure-proof vessel to the gas pressure of one atmospheric pressure or higher.

Further, in the present invention, inert gas is preferably supplied to the pressure-proof vessel before the gas including hydrogen gas and substantially including no reactive gas as impurity gas is introduced to the pressure-proof vessel to replace gas in the pressure-proof vessel by the inert gas.

As the inert gas, is employed inert gas selected from a group including nitrogen gas, helium gas, neon gas, argon gas, krypton gas, xenon gas and radon gas.

In the present invention, the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the pressure-proof vessel is heated, hydrogen gas is introduced to the pressure-proof vessel, and the pressure-proof vessel is sealed and held for a prescribed time, so that hydrogen is stored to the carbonaceous material.

In the present invention, after the pressure-proof vessel is heated, hydrogen gas is preferably introduced to the pressure-proof vessel to store hydrogen to the carbonaceous material under the pressure of hydrogen lower than 50 atmospheric pressure. Thus, since the carbonaceous material is heated, the surface of the carbonaceous material can be efficiently cleaned, an area where the surface of the carbonaceous material comes into contact with hydrogen atoms or hydrogen molecules can be greatly increased and a large amount of hydrogen can be efficiently stored to the carbonaceous material.

In the present invention, preferably, the pressure-proof vessel is sealed and held for a prescribed time under the pressure of hydrogen lower than 50 atmospheric pressure, so that hydrogen is stored to the carbonaceous material.

Further, hydrogen gas is introduced to the pressure-proof vessel and the pressure-proof vessel is preferably held for a prescribed time under the pressure of hydrogen of 10 atmospheric pressure or lower.

The pressure-proof vessel is preferably heated at the temperature of 100° C. or higher. Further, the pressure-proof vessel is preferably heated at the temperature of 200° C. to 1200° C. Still further, the pressure-proof vessel is preferably heated at the temperature of 600° C. to 1200° C. Still further, the pressure-proof vessel is preferably heated at the temperature of 800° C. to 1000° C.

In the present invention, the inert gas is preferably introduced to the pressure-proof vessel before the pressure-proof vessel is heated to heat the pressure-vessel under an inert gas atmosphere.

The inert gas used here is composed of inert gas selected from a group including nitrogen gas, helium gas, neon gas, argon gas, krypton gas, xenon gas and radon gas.

In the present invention, the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, reducing gas is introduced to the pressure-proof vessel, and the pressure-proof vessel is sealed, heated to the temperature of 50° C. or higher and then, the pressure-proof vessel is opened to introduce hydrogen thereto, then sealed and held for a prescribed time, and accordingly, hydrogen is stored to the carbonaceous material.

In the present invention, since the reducing gas is preferably introduced to the pressure-proof vessel, and the pressure-proof vessel is heated to the temperature of 50° C. or higher, the carbonaceous material is heated under the atmosphere of reducing gas. Thus, the surface of the carbonaceous material can be efficiently cleaned, an area where the surface of the carbonaceous material comes into contact with hydrogen atoms or hydrogen molecules can be greatly increased and a large amount of hydrogen can be efficiently stored to the carbonaceous material.

In this case, as the reducing gas, is used reducing gas composed of gas selected from a group including carbon monoxide gas, nitric oxide gas, nitrous oxide gas and ammonia gas. The reducing gas is desirably composed of carbon monoxide gas.

In the present invention, the reducing gas is introduced to the pressure-proof vessel and while the pressure of the pressure-proof vessel is maintained at the gas pressure not lower than one atmospheric pressure, the pressure-proof vessel is heated.

In the present invention, the surface of the carbonaceous material can be more effectively cleaned and a large amount of hydrogen can be more efficiently stored to the carbonaceous material.

In the present invention, hydrogen gas is introduced together with the reducing gas to the pressure-proof vessel and the pressure-proof vessel is sealed and heated at the temperature of 50° C. or higher.

In the present invention, the pressure-proof vessel is preferably heated at the temperature lower than 1500° C. Further, the pressure-proof vessel is preferably heated at the temperature of 200° C. to 1400° C.

In the present invention, since the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, the pressure-proof vessel is heated at the temperature of 800° C. or lower, and then, hydrogen gas is introduced to the pressure-proof vessel, and the pressure-proof vessel is sealed and held for a prescribed time, hydrogen is stored to the carbonaceous material.

Further, the carbonaceous material is heated at the temperature of 800° C. or lower before the hydrogen is stored under the pressure of hydrogen not lower than 50 atmospheric pressure, so that chemisorbed or physisorbed molecules on the surface of the carbonaceous material can be effectively removed, an area where the surface of the carbonaceous material comes into contact with hydrogen atoms or hydrogen molecules can be greatly increased and a large amount of hydrogen can be efficiently stored to the carbonaceous material.

The pressure-proof vessel is preferably sealed and held for a prescribed time under the hydrogen pressure not lower than 50 atmospheric pressure, so that hydrogen is stored to the carbonaceous material. In this case, the pressure-proof vessel is heated at the temperature of 100° C. to 800° C.

Further, the inert gas is preferably introduced to the pressure-proof vessel before the pressure-proof vessel is heated and the pressure-proof vessel is heated under an inert gas atmosphere.

The inert gas used here is composed of gas selected from a group including nitrogen gas, helium gas, neon gas, argon gas, krypton gas, xenon gas and radon gas.

In the present invention, since the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the pressure of the pressure-proof vessel is reduced, the pressure-proof vessel is heated at the temperature of 230° C. or higher under a pressure reduced state, then, hydrogen gas is introduced to the pressure-proof vessel, and the pressure-proof vessel is sealed and held for a prescribed time, hydrogen is stored to the carbonaceous material.

In this case, the pressure-proof vessel is preferably heated at the temperature of 400° C. to 800° C.

As the carbonaceous material employed for the present invention, a carbonaceous material having a large surface area and a structural curvature is selected. According to the study of the inventors of the present invention, since the carbonaceous material having the curvature belongs to a—non-orthogonal electron system, it is found that HOMO and LUMO are lower than those of a—orthogonal electron system. Therefore, the carbonaceous material with the curvature can become a strong electron acceptor and separate the hydrogen atoms into electrons and protons (atomic nucleuses of hydrogen) to store the hydrogen with high density in the form of the protons having no volume.

The carbonaceous material employed in the present invention is composed of a carbonaceous material selected from a group including fullerene, carbon nanofiber, carbon nanotube, carbon soot, nanocapsule, bucky onion and carbon fiber. As the fullerene, any spheroidal carbon molecules may be used and all spheroidal carbon molecules having the number of carbons such as 36, 60, 70, 72, 74, 76, 78, 80, 82, 84, etc. may be utilized in the present invention.

A hydrogen storing and desorbing apparatus according to the present invention comprises a pressure-proof vessel; a cartridge whose outside diameter is smaller than the inside diameter of the pressure-proof vessel and whose outer peripheral wall part and bottom wall part are made of a porous material and which can accommodate a carbonaceous material therein; holding means for holding the cartridge in the pressure-proof vessel so that the bottom wall part of the cartridge is spaced from the bottom surface of the pressure-proof vessel and the outer peripheral wall part of the cartridge is spaced from the inner side surface of the pressure-proof vessel; gas passages connected to the pressure-proof vessel; valves provided in the gas passages and a hydrogen gas supply source connected to the pressure-proof vessel by the gas passage.

Since the hydrogen storing and desorbing apparatus comprises a pressure-proof vessel; a cartridge whose outside diameter is smaller than the inside diameter of the pressure-proof vessel and whose outer peripheral wall part and bottom wall part are made of a porous material and which can accommodate a carbonaceous material therein; holding means for holding the cartridge in the pressure-proof vessel so that the bottom wall part of the cartridge is spaced from the bottom surface of the pressure-proof vessel and the outer peripheral wall part of the cartridge is spaced from the inner side surface of the pressure-proof vessel; gas passages connected to the pressure-proof vessel; valves provided in the gas passages and a hydrogen gas supply source connected to the pressure-proof vessel by the gas passage, the valve is opened to introduce hydrogen gas to the pressure-proof vessel from the hydrogen gas supply source after the carbonaceous material for storing hydrogen is housed in the cartridge, then, the valve is closed to hold the vessel for a prescribed time, so that the hydrogen gas is stored to the carbonaceous material through the outer peripheral wall part and bottom wall part of the cartridge made of the porous material. Therefore, the carbonaceous material can come into contact with the hydrogen in a large area and a large amount of hydrogen can be efficiently stored to the carbonaceous material and the stored hydrogen can be desorbed through the gas passage by opening the valve.

The cross-section of the cartridge used in the hydrogen storing and desorbing apparatus according to the present invention is annular shape and the inner peripheral wall part of the cartridge is formed of a porous material. Since the cross-section of the cartridge is annular shape and the inner peripheral wall part of the cartridge is formed of the porous material, hydrogen can be stored to the carbonaceous material through the outer peripheral wall part, the inner peripheral wall part and the bottom wall part of the cartridge made of the porous material, the carbonaceous material can come into contact with the hydrogen in a larger area and a large amount of hydrogen can be more efficiently stored by the carbonaceous material.

The hydrogen storing and desorbing apparatus according to the present invention further comprises a heating means for heating the pressure-proof vessel. In the hydrogen storing and desorbing apparatus, the valve is opened to introduce hydrogen gas to the pressure-proof vessel from the hydrogen gas supply source, the valve is closed and the pressure-proof vessel is heated by using the heating means and held for a prescribed time, so that the surface of the carbonaceous material can be cleaned by the hydrogen gas, the surface area of the carbonaceous material coming into contact with the hydrogen can be increased and hydrogen can be supplied to the carbonaceous material to efficiently store the hydrogen to the carbonaceous material.

Further, in the present invention, the pressure-proof vessel is heated by using the heating means to remove impurities adhering to the surface of the carbonaceous material in the cartridge, then, the valve is opened to introduce hydrogen gas to the pressure-proof vessel, and the valve is closed to hold the vessel for a prescribed time under the pressure of hydrogen lower than 50 atmospheric pressure, so that a large amount of hydrogen can be efficiently stored to the carbonaceous material.

Further, in the hydrogen storing and desorbing apparatus according to the present invention, a first selector valve and a second selector valve are provided in the gas passages, the hydrogen gas supply source is connected to the gas passage through the first selector valve, and further, an inert gas supply source connected to the gas passage through the second selector valve is provided.

Since the inert gas is supplied to the pressure-proof vessel through the gas passage from the inert gas supply source by opening the second selector valve before hydrogen is supplied to the pressure-proof vessel, and the carbonaceous material in the cartridge is heated by the heating means under an inert gas atmosphere, impurities adhering to the surface of the carbonaceous material can be removed to increase the surface area of the carbonaceous material capable of coming into contact with the hydrogen. Thus, the first selector valve is then opened to introduce the hydrogen gas to the pressure-proof vessel through the gas passage from the hydrogen gas supply source and the valve is closed to hold the vessel for a prescribed time, so that a large amount of hydrogen can be efficiently stored to the carbonaceous material.

In the hydrogen storing and desorbing apparatus according to the present invention, a third selector valve is provided in the gas passage and a reducing gas supply source is connected to the gas passage through the third selector valve. Since the reducing gas is supplied to the pressure-proof vessel through the gas passage from the reducing gas supply source by opening the third selector valve before the hydrogen is supplied to the pressure-proof vessel and the carbonaceous material in the cartridge is heated at the temperature of 50° C. or higher by the heating means under a reducing gas atmosphere, the surface of the carbonaceous material can be efficiently cleaned to efficiently remove impurities adhering to the surface of the carbonaceous material and greatly increase an area where the surface of the carbonaceous material comes into contact with hydrogen atoms or hydrogen molecules. Therefore, the first selector valve is then opened to introduce the hydrogen gas to the pressure-proof vessel through the gas passage from the hydrogen gas supply source and the valve is closed to hold the vessel for a prescribed time, so that a large amount of hydrogen can be efficiently stored to the carbonaceous material.

The holding means for holding the cartridge in the pressure-proof vessel are composed of at least three leg parts provided on the outer surface of the bottom wall part of the cartridge. The holding means are composed of one or two or more of plate type leg members provided on the outer surface of the bottom wall part of the cartridge. In the holding members, one or two or more of plate type leg members are preferably formed of a porous material. Further, the holding means preferably comprise at least two protruding parts provided on the outer wall part of the cartridge and engagement protruding parts provided on the inner surface of the pressure-proof vessel and capable of engaging with at least two protruding parts.

Further, the carbonaceous material used in the hydrogen storing and desorbing apparatus according to the present invention includes, on its surface, fine particles made of metal or a metallic alloy having a function for separating hydrogen atoms from hydrogen molecules, or further, separating protons and electrons from the hydrogen atoms. The average size of the fine particles made of the metal or the alloy is desirably 1 micrometer or smaller. As the metal, there is preferably employed metal or an alloy selected from a group including iron, rare earth elements, nickel, cobalt, palladium, rhodium, platinum or alloys composed of one or two or more of these metals.

When the carbonaceous material having the curvature such as fullerene, carbon nanofiber, carbon nanotube, carbon soot, nanocapsule, bucky onion and carbon fiber or the like is produced by an arc discharge method, the metals or the alloys thereof are preferably mixed into a graphite rod before the arc discharge. At the time of the arc discharge, the above described metals or the alloys thereof are allowed to exist, so that the yield of the carbonaceous material can be enhanced and the hydrogen storage carbonaceous material with the curvature can be urged to be produced in accordance with the catalytic action of these metals or the alloys thereof. It has been known that these metals or the alloys thereof perform a catalytic action when the carbonaceous material such as fullerene, carbon nanofiber, carbon nanotube and carbon fiber or the like is produced by a laser ablation method. The carbonaceous material such as fullerene, carbon nanofiber, carbon nanotube and carbon fiber or the like produced by the above described method may be collected, added to and mixed with the hydrogen storage carbonaceous material so that the surface of the hydrogen storage carbonaceous material includes these metals or the alloys thereof.

Further, the carbonaceous material including these metals or alloys thereof or the carbonaceous material including no metals nor alloys thereof carries at least on its surface metallic fine particles of 10 wt % or less which have a catalyzing function for separating hydrogen atoms from hydrogen molecules, and further, separating protons and electrons from the hydrogen atoms. As a preferable metal having such a catalyzing function, for instance, there may be exemplified platinum or a platinum alloy, etc. In order to carry these metals on the surface of the carbonaceous material, a well-known method such as a sputtering method, a vacuum deposition method, a chemical method, a mixture or the like may be used.

Further, when platinum fine particles or platinum alloy fine particles are carried on the carbonaceous material, a chemically carrying method using solution containing platinum complexes or an arc discharge method using electrodes including platinum may be applied thereto. In the chemically carrying method, for instance, chloroplatinic acid solution is treated with sodium hydrogen sulfite or hydrogen peroxide, then, the carbonaceous material is added to the resultant solution and the solution is agitated so that the platinum fine particles or the platinum alloy fine particles can be carried on the carbonaceous materials. On the other hand, in the arc discharge method, the platinum or the platinum alloy is partly attached to the electrode part of the arc discharge, and is subjected to the arc discharge to be evaporated so that the platinum or the platinum alloy can be adhered to the carbonaceous material housed in a chamber.

The above described metals or the alloys thereof are carried on the carbonaceous material, so that the hydrogen storage capacity can be more improved than that when the metals or the alloys thereof are not carried on the carbonaceous material. Further, it is found that fluorine serving as an electron donor or an amine molecule such as ammonia is mixed or combined with the carbonaceous material to efficiently generate a charge separation.

As described above, hydrogen composed of protons and electrons is supplied to the hydrogen storage carbonaceous material as a strong electron acceptor on which the above mentioned metals or the alloys are mounted, hence the hydrogen is stored in the form of protons. Therefore, its occupied volume is greatly reduced and a large amount of hydrogen can be stored in the hydrogen storage carbonaceous material as compared with the storage by the conventional chemisorption of hydrogen atoms. That is, the hydrogen is separated into electrons and protons from the state of atoms, and the electrons are efficiently stored in the hydrogen storage carbonaceous material so that a large amount of high density hydrogen can be finally stored in the state of protons. Accordingly, when the above described metals or the alloys are carried on the surface of the hydrogen storage carbonaceous material, the hydrogen can be more efficiently stored and a larger amount of hydrogen can be stored. The above described hydrogen storage carbonaceous material is light, easily transported, can be repeatedly employed at a level of room temperature without generating a structural destruction and can be safely handled. Further, the amount of use of a metallic catalyst such as platinum can be reduced. The carbonaceous material such as fullerene serving as a starting material can be also easily produced at a low cost. Further, there can be realized an excellent practicability that a problem is not found in view of the procurement of resources nor a problem such as an environmental destruction is generated during a use.

Still further objects and specific advantages obtained by the present invention will become more apparent from the description of embodiments or examples explained hereinafter.

### BRIEF DESCRIPTION OF THE DRAWINGS

FIG. 1 is a longitudinally sectional view showing a hydrogen storing and desorbing apparatus according to the present invention.

FIG. 2 is a perspective view showing a cartridge.

FIG. 3 is a longitudinally sectional view showing another embodiment of a hydrogen storing and desorbing apparatus according to the present invention.

FIG. 4 is a longitudinally sectional view showing other embodiment of a hydrogen storing and desorbing apparatus according to the present invention.

FIG. 5 is a graph showing the relation between the gas pressure in a pressure-proof vessel and the lapse of time of the present invention and a Comparative Example.

FIG. 6 is a substantially perspective view showing an example of leg members provided on the outer surface of the bottom wall part of a cartridge.

FIG. 7 is a substantially perspective view showing another example of a leg member provided on the outer surface of the bottom wall part of a cartridge.

FIG. 8 is a substantially sectional view showing protruding parts provided on the outer wall part of a cartridge and engaging parts provided on the inner surface of a pressure-proof vessel.

### BEST MODE FOR CARRYING OUT THE INVENTION

Now, specific constructional examples of the present invention will be described below by referring to the drawings.

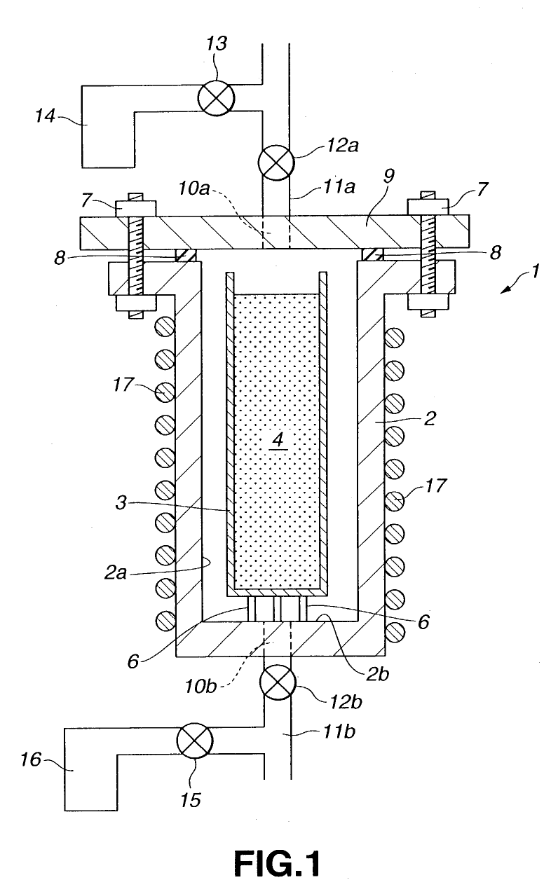

A hydrogen storing and desorbing apparatus 1 according to the present invention comprises, as shown in FIG. 1, a pressure-proof vessel 2 and a cartridge 3 housed in the pressure-proof vessel 2. A carbon nanotube 4 is provided in the cartridge 3.

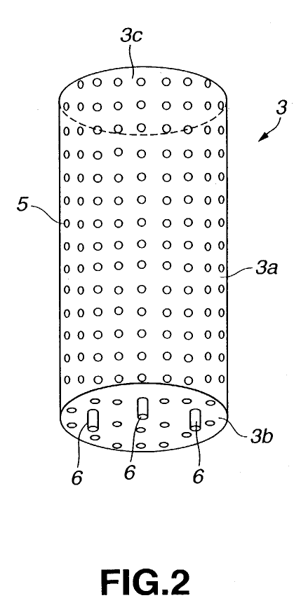

The cartridge 3 provided in the pressure-proof vessel 2 is, as shown in FIG. 2, formed in a cylindrical shape by using a stainless steel. On an outer peripheral wall part 3a and a bottom wall part 3b of the cartridge, many holes 5 are formed. On the outer surface of the bottom wall part 3b, three leg parts 6, 6, and 6 are provided. On one end face perpendicular to the axis of the cartridge 3, an opening part 3c is formed.

The three leg parts 6, 6 and 6 provided on the outer surface of the bottom wall part 3b of the cartridge 3 abut on the bottom surface 2b of the pressure-proof vessel 2, as shown in FIG. 1. The outer surface of the bottom wall part 3b of the cartridge 3 is arranged so as to be spaced from the bottom surface 2b of the pressure-proof vessel 2 so that a space is formed between the outer surface of the bottom wall part 3b of the cartridge 3 and the bottom surface 2b of the pressure-proof vessel 2. The cartridge 3 has an outside diameter smaller than the inside diameter of the pressure-proof vessel 2. As shown in FIG. 1, the outer peripheral wall part 3a of the cartridge 3 is arranged so as to be spaced from the inner side surface 2a of the pressure-proof vessel 2 so that a space is formed between the outer peripheral wall part 3a of the cartridge 3 and the inner side surface 2a of the pressure-proof vessel 2.

As shown in FIG. 1, a cover member 9 is fixed to the pressure-proof vessel 2 by screws 7 and the pressure-proof vessel 2 is sealed by a metal seal 8. On the cover member 9, a first opening part 10a is formed and a first gas passage 11a is connected to the first opening part 10a.

As shown in FIG. 1, a first valve 12a is provided in the first gas passage 11a and a hydrogen gas supply source 14 is connected to the first gas passage 11a through a first selector valve 13. On the other hand, on the bottom part of the pressure-proof vessel 2, a second opening part 10b is formed. A second gas passage 11b is connected to the second opening part 10b.

As shown in FIG. 1, a second valve 12b is provided in the second gas passage 11b and a nitrogen gas supply source 16 is connected to the second gas passage 11b through a second selector valve 15.

On the periphery of the pressure-proof vessel 2, a heating coil 17 is wound.

In the hydrogen storing and desorbing apparatus 1 according to the present invention constructed as described above, hydrogen is stored by a carbon nanotube 4 contained in the cartridge 3 and the stored hydrogen is desorbed in such a manner as described below.

Initially, the carbon nanotube 4 as a carbonaceous material for storing hydrogen is provided in the cartridge 3. Then, the cartridge 3 is provided in the pressure-proof vessel 2 so that the space is formed between the bottom wall part 3b of the cartridge 3 and the bottom surface 2b of the pressure-proof vessel 2 and the space is formed between the outer peripheral wall part 3a of the cartridge 3 and the inner side surface 2a of the pressure-proof vessel 2. The cover member 9 is fixed to the pressure-proof vessel 2 by the screws 7 and the pressure-proof vessel 2 is sealed by the metal seal 8.

After that, the second valve 12b is opened, and further, the second selector valve 15 is opened so that nitrogen gas is introduced to the pressure-proof vessel 2 through the second gas passage 11b from the nitrogen gas supply source 16. At that time, an electric current is supplied to the heating coil 17 from a power source (not shown). The pressure-proof vessel 2 is heated for 3 hours by the heating coil 17 so that the carbon nanotube 4 in the cartridge 3 is heated at the temperature of 800° C. to 1000° C. under a nitrogen gas atmosphere.

In such a way, the pressure-proof vessel 2 is heated by the heating coil 17 and the carbon nanotube 4 in the cartridge 3 is heated at the temperature of 800° C. to 1000° C. to remove impurities adhering to the surface of the carbon nanotube 4.

When the supply of electric current to the heating coil 17 is shut off and it is recognized that the temperature in the pressure-proof vessel 2 is reset to room temperature, the second selector valve 15 is closed and the first valve 12a and the first selector valve 13 are opened so that the hydrogen gas of 100 atmospheric pressure is introduced to the pressure-proof vessel 2 through the first gas passage 11a from the hydrogen gas supply source 14. As a result, the nitrogen gas in the pressure-proof vessel 2 is ejected to the second gas passage 11b through the second opening part 10b so that the nitrogen gas in the pressure-proof vessel 2 is replaced by the hydrogen gas. Here, since the nitrogen gas is heavier than the hydrogen gas, the hydrogen gas is introduced to the pressure-proof vessel 2 from the first opening part 10a formed on the cover member 9, hence the nitrogen gas can be rapidly ejected to the second gas passage 11b from the second opening part 10b formed on the bottom part of the pressure-proof vessel 2 and the nitrogen gas can be replaced by the hydrogen gas.

When the nitrogen gas in the pressure-proof vessel 2 is completely replaced by the hydrogen gas, the first selector valve 13, the first valve 12a and the second valve 12b are closed.

In the present invention, since the cartridge 3 is provided in the pressure-proof vessel 2 so that the space is formed between the outer surface of the bottom wall part 3b of the cartridge 3 and the bottom surface 2b of the pressure-proof vessel 2 and the space is formed between the outer peripheral wall part 3a of the cartridge 3 and the inner side surface 2a of the pressure-proof vessel 2 and many holes are formed on the outer peripheral wall part 3a and the bottom wall part 3b of the cartridge 3, the carbon nanotube 4 contained in the cartridge 3 comes into contact with the hydrogen gas introduced to the pressure-proof vessel 2 from the hydrogen gas supply source 14 through the opening part 3c of the cartridge 3, many holes 5 formed on the outer peripheral wall part 3a of the cartridge 3 and many holes 5 formed on the bottom wall part 3b of the cartridge 3. Thus, a contact area of the carbon nanotube 4 with the hydrogen gas is more greatly increased than a case in which the carbon nanotube 4 comes into contact with the hydrogen gas through the opening part 3c of the cartridge 3 as in the prior art, so that a large amount of hydrogen can-be efficiently stored to the carbon nanotube 4. Thus, with the lapse of a prescribed time, the storing of hydrogen is completed.

When the hydrogen stored by the carbon nanotube 4 is desorbed, the first valve 12a and the second valve 12b are opened and the second selector valve 15 is opened so that the nitrogen gas is introduced to the pressure-proof vessel 2 through the second gas passage 11b and the second opening part 10b from the nitrogen gas supply source 16, so that the hydrogen is replaced by the nitrogen gas and the hydrogen stored by the carbon nanotube 4 is ejected to the first gas passage 11a through the first opening part 10a.

Here, since the hydrogen gas is extremely lighter than the nitrogen gas, the nitrogen gas is introduced to the pressure-proof vessel 2 from the second opening part 10b formed on the bottom part of the pressure-proof vessel 2, and accordingly, the hydrogen gas can be ejected to the first gas passage 11a from the first opening part 10a formed on the cover member 9.

In the present invention, many holes 5 are formed on the outer peripheral wall part 3a and the bottom wall part 3b of the cartridge 3 for providing the carbon nanotube 4 which stores the hydrogen, the three leg parts 6, 6 and 6 provided on the outer surface of the bottom wall part 3b of the cartridge 3 abut on the bottom surface 2b of the pressure-proof vessel 2 and the outer surface of the bottom wall part 3b of the cartridge 3 is arranged so as to be spaced from the bottom surface 2b of the pressure-proof vessel 2. Further, since the cartridge 3 has the outside diameter smaller than the inside diameter of the pressure-proof vessel 2 and the outer peripheral wall part 3a of the cartridge 3 is arranged so as to be spaced from the inner side surface 2a of the pressure-proof vessel 2, the space is formed between the outer surface of the bottom wall part 3b of the cartridge 3 and the bottom surface 2b of the pressure-proof vessel 2, and the space is formed between the outer peripheral wall part 3a of the cartridge 3 and the inner side surface 2a of the pressure-proof vessel 2. Consequently, the carbon nanotube 4 contained in the cartridge 3 comes into contact with the hydrogen gas introduced to the pressure-proof vessel 2 from the hydrogen gas supply source 14 through the opening part 3c of the cartridge 3, many holes 5 formed on the outer peripheral wall part 3a of the cartridge 3 and many holes 5 formed on the bottom wall part 3b of the cartridge 3. Thus, the contact area of the carbon nanotube 4 with the hydrogen gas is more greatly increased than that of a conventional case in which the carbon nanotube 4 comes into contact with the hydrogen gas through the opening part 3c of the cartridge 3, so that a large amount of hydrogen can be efficiently stored to the carbon nanotube 4.

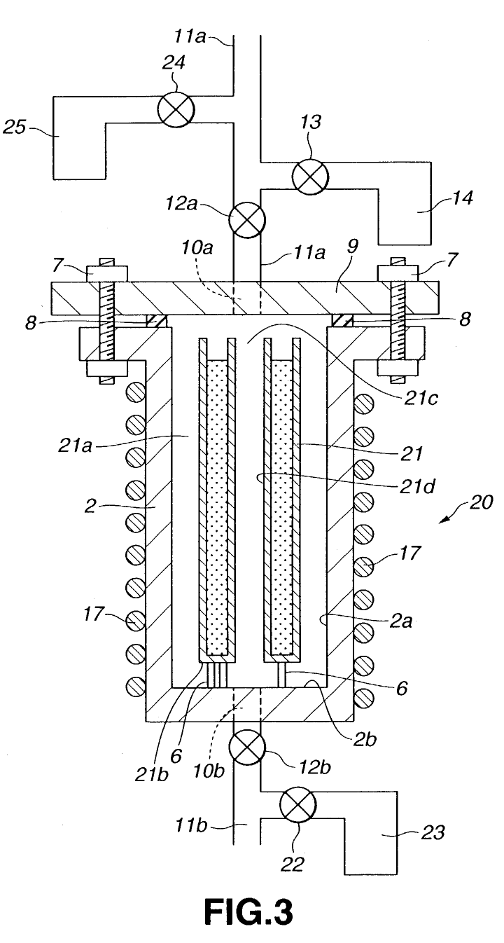

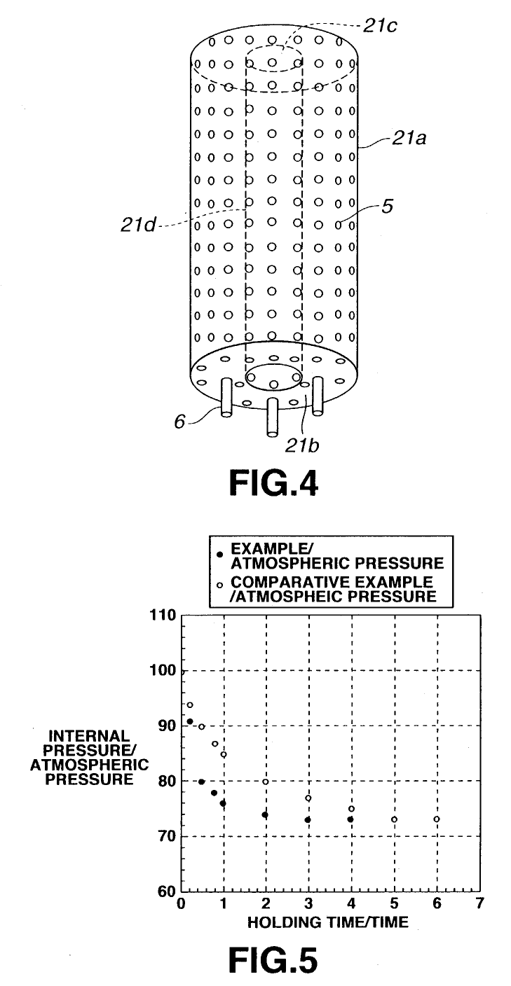

FIG. 3 shows another embodiment of a hydrogen storing and desorbing apparatus according to the present invention. A cartridge employed in the apparatus shown in FIG. 3 is shown in FIG. 4.

The hydrogen storing and desorbing apparatus 20 of another embodiment of the present invention has the same construction as that shown in FIGS. 1 and 2 except that a cartridge 21 whose cross-section is annular shape is provided, a carbon monoxide gas supply source 23 is connected to a second gas passage 11b through a third selector valve 22, in place of the nitrogen gas supply source 16 connected to the second gas passage 11b through the second selector valve 15, and a vacuum pump 25 is connected to a first gas passage 11a through a fourth selector valve 24 as shown in FIGS. 3 and 4.

The cartridge 21 is annular in its cross-section, as shown in FIG. 4 and has many holes 5 formed not only on an outer peripheral wall part 21a and a bottom wall part 21b, but also on an inner peripheral wall part 21d. In FIG. 4, 21c denotes an opening part of the cartridge 21.

In the hydrogen storing and desorbing apparatus 20 according to the present invention having the above described construction, hydrogen is stored to a carbon nanotube 4 contained in the cartridge 21 and the stored hydrogen is desorbed in such a manner as described below.

Initially, the carbon nanotube 4 as a carbonaceous material for storing hydrogen is provided in the cartridge 20. Then, the cartridge 21 is provided in a pressure-proof vessel 2 so that the space is formed between the bottom wall part 20b of the cartridge 20 and the bottom surface 2b of the pressure-proof vessel 2 and the space is formed between the outer peripheral wall part 21a of the cartridge and the inner side surface 2a of the pressure-proof vessel 2. A cover member 9 is fixed to the pressure-proof vessel 2 by screws 7 and the pressure-proof vessel 2 is sealed by a metal seal 8.

After that, when a first valve 12a is opened, further, the fourth selector valve 24 is opened, and then the vacuum pump 25 is operated so that pressure in the pressure-proof vessel 2 is reduced, an electric current is supplied to a heating coil 17 from a power source (not shown). The pressure-proof vessel 2 is heated for 3 hours by the heating coil 17 so that the carbon nanotube 4 in the cartridge 3 is heated at the temperature of 400° C. to 800° C. under a pressure reduced state.

In such a way, the pressure-proof vessel 2 is heated by the heating coil 17, so that and the carbon nanotube 4 in the cartridge 3 is heated at the temperature of 400° C. to 800° C. under the pressure reduced state to remove impurities adhering to the surface of the carbon nanotube 4.

When the supply of electric current to the heating coil 47 is shut off and it is recognized that the temperature in the pressure-proof vessel 2 is reset to room temperature, the fourth selector valve 24 is closed and a first selector valve 13 is opened so that hydrogen gas of 100 atmospheric pressure is introduced to the pressure-proof vessel 2 through a first gas passage 11a from a hydrogen gas supply source 14. After that, the first selector valve 13 and the first valve 12a are closed.

In the present invention, since the cartridge 21 is provided in the pressure-proof vessel 2 so that the space is formed between the outer surface of the bottom wall part 21b of the cartridge 21 and the bottom surface 2b of the pressure-proof vessel 2 and the space is formed between the outer peripheral wall part 21a of the cartridge 21 and the inner side surface 2a of the pressure-proof vessel 2, the cartridge 21 has an annular cross-section, the cartridge 21 has an annular cross-section and many holes 5 are formed on the outer peripheral wall part 21a and the bottom wall part 21b and the inner peripheral wall part 21d of the cartridge 21, the carbon nanotube 4 contained in the cartridge 21 comes into contact with the hydrogen gas introduced to the pressure-proof vessel 2 from the hydrogen gas supply source 14 through the opening part 21c of the cartridge 21, many holes 5 formed on the outer peripheral wall part 21a of the cartridge 21, many holes 5 formed on the bottom wall part 3b of the cartridge 21 and many holes 5 formed on the inner peripheral wall part 21d of the cartridge 21. Thus, a contact area of the carbon nanotube with the hydrogen gas is more greatly increased than a case in which the carbon nanotube 4 comes into contact with the hydrogen gas through the opening part 3c of the cartridge 3 as in the prior art, so that a large amount of hydrogen can be efficiently stored to the carbon nanotube 4. Thus, with the lapse of a prescribed time, the storing of hydrogen is completed.

When the hydrogen stored by the carbon nanotube 4 is desorbed, the first valve 12a and the second valve 12b are opened and a third selector valve 22 is opened so that carbon monoxide gas is introduced to the pressure-proof vessel 2 through a second gas passage 11b and a second opening part 10b from a carbon monoxide gas supply source 23, so that the hydrogen is replaced by carbon monoxide gas and the hydrogen stored by the carbon nanotube 4 is ejected to the first gas passage 11a through a first opening part 10a.

Here, since the hydrogen gas is extremely lighter than the carbon monoxide gas, the carbon monoxide gas is introduced to the pressure-proof vessel 2 from a second opening part 10b formed on the bottom part of the pressure-proof vessel 2, and accordingly, the hydrogen gas can be ejected to the first gas passage 11a from the first opening part 10a formed on the cover member 9.

In the present invention, the cartridge 21 which accommodates the carbon nanotube 4 for storing hydrogen is annular in its cross-section, many holes 5 are formed on the outer peripheral wall part 21a, the bottom wall part 21b and the inner peripheral wall part 21d of the cartridge 21, three leg parts 6, 6 and 6 provided on the outer surface of the bottom wall part 21b of the cartridge 21 abut on the bottom surface 2b of the pressure-proof vessel 2 and the outer surface of the bottom wall part 21b of the cartridge 21 is arranged so as to be spaced from the bottom surface 2b of the pressure-proof vessel 2. Further, since the cartridge 21 has an outside diameter smaller than the inside diameter of the pressure-proof vessel 2 and the outer peripheral wall part 21a of the cartridge 21 is arranged so as to be spaced from the inner side surface 2a of the pressure-proof vessel 2, the space is formed between the outer surface of the bottom wall part 21b of the cartridge 21 and the bottom surface 2b of the pressure-proof vessel 2, and the space is formed between the outer peripheral wall part 21 a of the cartridge 21 and the inner side surface 2a of the pressure-proof vessel 2. Consequently, the carbon nanotube 4 contained in the cartridge 21 comes into contact with the hydrogen gas introduced to the pressure-proof vessel 2 from the hydrogen gas supply source 14 through the opening part 3c of the cartridge 3, many holes 5 formed on the outer peripheral wall part 3a of the cartridge 3, many holes 5 formed on the bottom wall part 3b of the cartridge 3 and many holes 5 formed on the inner peripheral wall part 21d of the cartridge 21. Thus, the contact area of the carbon nanotube 4 with the hydrogen gas is more greatly increased than that of a conventional case in which the carbon nanotube 4 comes into contact with the hydrogen gas through the opening part 3c of the cartridge 3, so that a large amount of hydrogen can be efficiently stored to the carbon nanotube 4.

In order to more clarify the effects of the present invention, an Example and a Comparative Example will be described below.

### EXAMPLE

The hydrogen storing and desorbing apparatus shown in FIG. 1 was assembled in the Example of the present invention by using a cylindrical pressure-proof vessel made of a stainless steel with a diameter of 10 mm and length of 50 mm as an inner size, and a cartridge made of a stainless steel mesh with a diameter of 8 mm and length of 40 mm as an inner size.

Here, a carbon nanofiber of 0.2 g produced by a CVD method was set to the cartridge. Three leg parts with the length of 2 mm were provided on the bottom surface of the cartridge and the cartridge was provided in the pressure-proof vessel so that a space of 2 mm was formed between the bottom surface of the cartridge and the bottom surface of the pressure-proof vessel.

While the pressure-proof vessel was degasified by using a rotary pump, the temperature of the pressure-proof vessel was raised to 200° C. by using a heating coil and held for 3 hours to clean the surface of the carbon nanofiber.

Then, the heating operation was stopped to recognize that the temperature of the pressure-proof vessel became room temperature, then, hydrogen gas of 100 atmospheric pressure was introduced to measure gas pressure in the pressure-proof vessel and the amount of stored hydrogen was calculated.

The amount of stored hydrogen after the hydrogen was stored to the carbon nanofiber for 5 hours was 3.0 wt %. In this case, the amount of stored hydrogen is a value obtained by dividing a mass of stored hydrogen by a mass of carbon.

The relation between the lapse of time and the calculated result is shown in FIG. 5.

### COMPARATIVE EXAMPLE

Hydrogen was stored to a carbon nanofiber, the gas pressure in the pressure-proof vessel was measured and the amount of stored hydrogen was calculated in the same manner as that of the Example of the present invention except that the carbon nanofiber of 0.2 g produced by a CVD method was set in the pressure-proof vessel without using a cartridge.

The amount of stored hydrogen obtained after the hydrogen was stored to the carbon nanofiber for 5 hours was 3.0 wt %.

The relation between the lapse of time and the calculated result is shown in FIG. 5.

As shown in FIG. 5, it was recognized that, in the Example of the present invention, gas pressure in the pressure-proof vessel was quickly lowered with the lapse of time to reach a balanced state, and, on the other hand, the lowering speed of the gas pressure in the pressure-proof vessel was small in the Comparative Example, and hydrogen was rapidly and efficiently stored into the carbon nanofiber in the Example as compared with the Comparative Example.

The present invention is not limited to the above described constructions or the embodiments and various kinds of changes may be performed within a scope without departing the gist of the present invention.

For example, in the apparatus shown in FIGS. 1 and 2, although the nitrogen gas supply source 16 is connected to the second gas passage 11b through the second selector valve 15, and in the apparatus shown in FIGS. 3 and 4, the carbon monoxide gas supply source 23 is connected to the second gas passage 11b through the third selector valve 22 and the vacuum pump 25 is connected to the first gas passage 11a through the fourth selector valve 24, the vacuum pump 25 may be connected to the first gas passage 11a through the fourth selector valve 24 and the carbon monoxide gas supply source 23 may be connected to the second gas passage 11b through the third selector valve 22 in the apparatus shown in FIGS. 1 and 2, and the nitrogen gas supply source 16 may be connected to the second gas passage 11b through the second selector valve 15 in the apparatus shown in FIGS. 3 and 4. The hydrogen storing and desorbing apparatus 1 or 20 may include all or at least one of the nitrogen gas-supply source 16, the carbon monoxide gas supply source 23 and the vacuum pump 25, or may not include all of them.

Further, although the hydrogen storing and desorbing apparatus 1 shown in FIGS. 1 and 2 is provided with the nitrogen gas supply source 16, the apparatus may include a gas supply source capable of supplying inert gas selected from a group including helium gas, neon gas, argon gas, krypton gas, xenon gas and radon gas, in place of the nitrogen gas supply source 16.

Further, although the hydrogen storing and desorbing apparatus 20 shown in FIGS. 3 and 4 is provided with the carbon monoxide gas supply source 23, the apparatus may include a gas supply source capable of supplying reducing gas selected from a group including nitric oxide gas, nitrous oxide gas and ammonia gas, in place of the carbon monoxide gas supply source 23.

Still further, although the hydrogen storing and desorbing apparatus 1 or 20 according to the present invention is provided with the heating coil 17, a means for heating the pressure-proof vessel 2 is not limited to the heating coil 17 and any arbitrary heating means may be provided, in place of the heating coil 17 wound on the pressure-proof vessel 2.

Further, although, in the hydrogen storing and desorbing apparatus 1 shown in FIGS. 1 and 2, the carbon nanotube 4 is heated under the atmosphere of inert nitrogen gas to clean the surface of the carbon nanotube 4, the gas including hydrogen gas and substantially including no reactive gas as inert gas, preferably, hydrogen gas may be introduced to the pressure-proof vessel 2, in place of the nitrogen gas, to heat the pressure-proof vessel, clean the surface of the carbon nanotube 4 and store hydrogen into the carbon nanotube under the atmosphere of the same hydrogen gas.

Further, although, in the hydrogen storing and desorbing apparatus 20 shown in FIGS. 3 and 4, the pressure of the pressure-proof vessel 2 is reduced by using the vacuum pump 25 to heat the carbon nanotube 4 under the pressure reduced state and clean the surface of the carbon nanotube 4, the carbon monoxide gas may be introduced to the pressure-proof vessel 2 from the carbon monoxide gas supply source 23 to heat the carbon nanotube 4 and clean the surface of the carbon nanotube 4 without employing the vacuum pump 25.

Further, although the hydrogen gas of 100 atmospheric pressure is introduced to store hydrogen in the above described embodiments, the storing pressure of hydrogen gas is not especially limited and the hydrogen gas may be stored under desired pressure in accordance with a purpose and a situation.

Still further, although the carbon nanotube is employed as the carbonaceous material, and further, the carbon nanofiber is employed as the carbonaceous material, the carbonaceous material used in the present invention is not limited to the carbon nanotube and the carbon nanofiber, and fullerene, carbon soot, nanocapsule, bucky onion, carbon fiber, etc. may be preferably used as the carbonaceous material of the present invention.

Further, in the above described embodiments, although many holes 5 are formed on the wall parts of the cartridge 3 or 21 constituting the hydrogen storing and desorbing apparatus 1 or 20 according to the present invention, and the cartridge made of a stainless steel mesh is used in the above described embodiment, any construction may be employed for the cartridge, if the wall part of the cartridge is formed so as to easily transmit hydrogen. Accordingly, it is not essentially necessary to form many holes 5 on the wall parts of the cartridge 3 or 21, or to employ the cartridge made of the stainless steel mesh.

Further, although the hydrogen storing and desorbing apparatus 20 shown in FIGS. 3 and 4 employs the cartridge 21 annular in its cross-section, it is not necessarily required to have a cartridge 21 whose cross-section is annular, and any cross-sectional configuration may be arbitrarily selected if a cartridge has an annular passage formed in its central part to supply hydrogen gas.

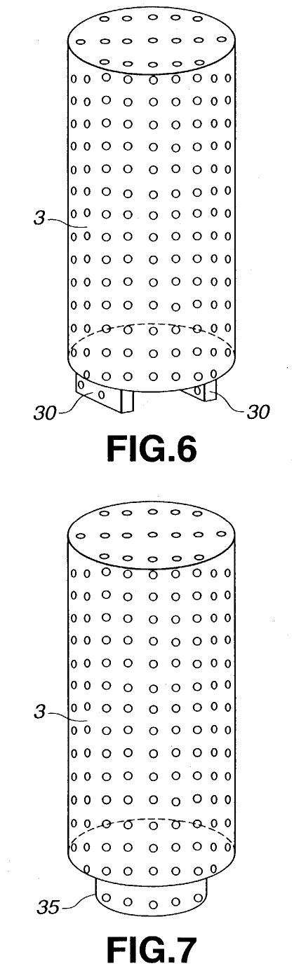

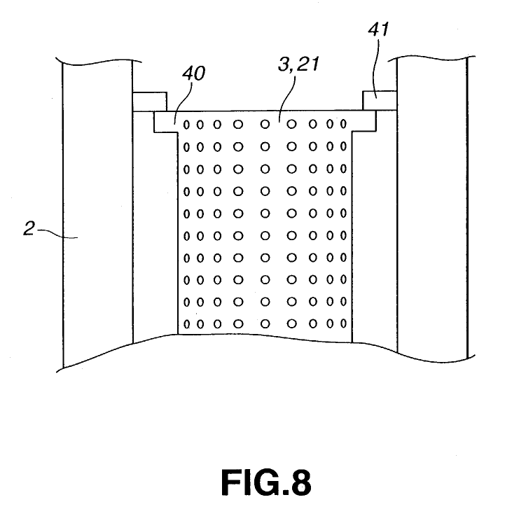

Still further, although the cartridge 3 or 21 has three leg parts 6, 6, and 6 on the outer surface of the bottom wall part 3b or 21b, the cartridge 3 or 21 may be satisfactorily arranged and provided in the pressure-proof vessel 2 so that the outer surface of the bottom wall part 3b or 21b of the cartridge 3 or 21 is spaced from the bottom surface 2b of the pressure-proof vessel 2. Therefore, it is not always necessary to provide the three leg parts 6,6 and 6 on the outer surface of the bottom wall part 3b or 21b of the cartridge 3 or 21. For instance, as shown in FIG. 6, two plate type leg members 30 and 30 formed of a porous material may be provided on the outer surface of the bottom wall part 3b of the cartridge 3. Further, as shown in FIG. 7, a ring shaped leg member 35 made of a porous material may be provided on the outer surface of the bottom wall part 3b of the cartridge 3 and the cartridge 3 may be provided in the pressure-proof vessel 2 so that the outer surface of the bottom wall part 3b of the cartridge 3 is spaced from the bottom surface 2b of the pressure-proof vessel 2. The above described matter may be applied to the cartridge 21 with an annular cross-section. Further, it is not necessarily needed to provide the leg parts 6, 6 and 6 or the plate type leg members 30 and 30 or the ring type leg member 35 in the cartridge 3 or 21. For instance, as shown in FIG. 8, the cartridge 3 or 21 may provided with at least two protruding parts 40 and 40 and engaging parts 41 and 41 capable of engaging with at least two protruding parts provided on the cartridge 3 or 21 may be provided on the inner surface 2a of the pressure-proof member 2. Then, the cartridge 3 or 21 may be arranged and provided in the pressure-proof vessel 2 so that the protruding parts 40 and 40 are engaged with the engaging parts 41 and 41 and the outer surface of the bottom wall part 3b or 21b of the cartridge 3 or 21 is spaced from the bottom surface 2b of the pressure-proof vessel 2.

Further, in the hydrogen storing and desorbing apparatus 20 shown in FIGS. 3 and 4, although the cartridge 21 is arranged in the pressure-proof vessel 2 so that the space is formed between the outer peripheral wall part 21a and the inner side surface 2a of the pressure-proof vessel 2, the cartridge 21 may be formed so that the outside diameter of the cartridge 21 is substantially equal to the inside diameter of the pressure-proof vessel 2 and the cartridge 21 may be arranged in the pressure-proof vessel 2 so that the outer peripheral wall part 21a of the cartridge 21 comes into contact with the inner side surface 2a of the pressure-proof vessel 2 and the hydrogen gas comes into contact with the carbon nanotube 4 through the opening part 21c of the cartridge 21, many holes 5 formed on the bottom wall part 21b and many holes 5 formed on the inner peripheral wall part 21d.

### INDUSTRIAL APPLICABILITY

According to the present invention, since the carbonaceous material is provided in the cartridge whose outer peripheral wall part and bottom wall part are made of a porous material, the cartridge is arranged and provided in the pressure-proof vessel whose inside diameter is larger than the outside diameter of the cartridge so that the bottom wall part of the cartridge is spaced from the bottom surface of the pressure-proof vessel, and the outer peripheral wall part of the cartridge is spaced from the inner side surface of the pressure-proof vessel, then, hydrogen is supplied to the pressure-proof vessel, and the pressure-proof vessel is sealed and held for a prescribed time, a large amount of hydrogen can be efficiently stored and hydrogen can be efficiently desorbed from a hydrogen storage material which stores hydrogen.

1. A method for producing a hydrogen storage material comprising the steps of:
providing a carbonaceous material in a cartridge whose outer peripheral wall part and bottom wall part are made of a porous material;
then, arranging the cartridge in a pressure-proof vessel having an inside diameter larger than the outside diameter of the cartridge so that the bottom wall part of the cartridge is spaced from the bottom surface of the pressure-proof vessel and the outer peripheral wall part of the cartridge is spaced from the inner side surface of the pressure-proof vessel; and
supplying hydrogen to the pressure-proof vessel, sealing the pressure-proof vessel and holding the pressure-proof vessel for a prescribed time.

2. The method for producing a hydrogen storage material according to claim 1, wherein the cross-section of the cartridge is annular shape and its inner peripheral wall part is made of a porous material.

3. The method for producing a hydrogen storage material according to claim 1, wherein the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the gas including hydrogen gas and substantially including no reactive gas as impurity gas is introduced to the pressure-proof vessel, and the pressure-proof vessel is sealed, heated and held for a prescribed time.

4. The method for producing a hydrogen storage material according to claim 3, wherein the pressure-proof vessel is heated to 50° C. or higher.

5. The method for producing a hydrogen storage material according to claim 3, wherein the gas including hydrogen gas and substantially including no reactive gas as impurity gas is supplied to held the pressure of the pressure-proof vessel to the gas pressure of one atmospheric pressure or higher.

6. The method for producing a hydrogen storage material according to claim 3, wherein inert gas is supplied to the pressure-proof vessel before the gas including hydrogen gas and substantially including no reactive gas as impurity gas is supplied to the pressure-proof vessel to replace gas in the pressure-proof vessel by the inert gas.

7. The method for producing a hydrogen storage material according to claim 6, wherein the inert gas is composed of inert gas selected from a group including nitrogen gas, helium gas, neon gas, argon gas, krypton gas, xenon gas and radon gas.

8. The method for producing a hydrogen storage material according to claim 1, wherein the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the pressure-proof vessel is heated, hydrogen gas is introduced to the pressure-proof vessel, and the pressure-proof vessel is sealed and held for a prescribed time.

9. The method for producing a hydrogen storage material according to claim 8, wherein the pressure-proof vessel is sealed and held for a prescribed time under the pressure of hydrogen lower than 50 atmospheric pressure.

10. The method for producing a hydrogen storage material according to claim 9, wherein hydrogen gas is introduced to the pressure-proof vessel and the pressure-proof vessel is held for a prescribed time under the pressure of hydrogen lower than 10 atmospheric pressure.

11. The method for producing a hydrogen storage material according to claim 8, wherein the pressure-proof vessel is heated at the temperature of 100° C. or higher.

12. The method for producing a hydrogen storage material according to claim 8, wherein the pressure-proof vessel is heated at the temperature of 200° C. to 1200° C.

13. The method for producing a hydrogen storage material according to claim 8, wherein the pressure-proof vessel is heated at the temperature of 600° C. to 1200° C.

14. The method for producing a hydrogen storage material according to claim 8, wherein the pressure-proof vessel is heated at the temperature of 800° C. to 1000° C.

15. The method for producing a hydrogen storage material according to claim 8, wherein inert gas is introduced to the pressure-proof vessel before the pressure-proof vessel is heated to heat the pressure-vessel under an inert gas atmosphere.

16. The method for producing a hydrogen storage material according to claim 15, wherein the inert gas is composed of inert gas selected from a group including nitrogen gas, helium gas, neon gas, argon gas, krypton gas, xenon gas and radon gas.

17. The method for producing a hydrogen storage material according to claim 1, wherein the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, reducing gas is introduced to the pressure-proof vessel, and the pressure-proof vessel is sealed, heated to the temperature of 50° C. or higher and then, the pressure-proof vessel is opened to introduce hydrogen thereto, sealed and held for a prescribed time.

18. The method for producing a hydrogen storage material according to claim 17, wherein the reducing gas is composed of gas selected from a group including carbon monoxide gas, nitric oxide gas, nitrous oxide gas and ammonia gas.

19. The method for producing a hydrogen storage material according to claim 18, wherein the reducing gas is composed of carbon monoxide gas.

20. The method for producing a hydrogen storage material according to claim 17, wherein the reducing gas is introduced to the pressure-proof vessel and while the pressure of the pressure-proof vessel is maintained at the gas pressure of one atmospheric pressure or higher, the pressure-proof vessel is heated.

21. The method for producing a hydrogen storage material according to claim 17, wherein hydrogen gas is introduced together with the reducing gas to the pressure-proof vessel and the pressure-proof vessel is sealed and heated at the temperature of 50° C. or higher.

22. The method for producing a hydrogen storage material according to claim 17, wherein the pressure-proof vessel is heated at the temperature lower than 1500° C.

23. The method for producing a hydrogen storage material according to claim 22, wherein the pressure-proof vessel is heated at the temperature of 200° C. to 1400° C.

24. The method for producing a hydrogen storage material according to claim 1, wherein the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, the pressure-proof vessel is heated at the temperature of 800° C. or lower, and then, hydrogen gas is introduced to the pressure-proof vessel, and the pressure-proof vessel is sealed and held for a prescribed time.

25. The method for producing a hydrogen storage material according to claim 24, wherein the pressure-proof vessel is sealed and held for a prescribed time under the hydrogen pressure not lower than 50 atmospheric pressure.

26. The method for producing a hydrogen storage material according to claim 24, wherein the pressure-proof vessel is heated at the temperature of 100° C. to 800° C.

27. The method for producing a hydrogen storage material according to claim 24, wherein inert gas is supplied to the pressure-proof vessel before the pressure-proof vessel is heated and the pressure-proof vessel is heated under an inert gas atmosphere.

28. The method for producing a hydrogen storage material according to claim 27, wherein the inert gas is composed of inert gas selected from a group including nitrogen gas, helium gas, neon gas, argon gas, krypton gas, xenon gas and radon gas.

29. The method for producing a hydrogen storage material according to claim 1, wherein the cartridge is disposed and provided in the pressure-proof vessel so that the bottom wall part of the cartridge is spaced from the bottom surface of the pressure-proof vessel and the outer peripheral wall part of the cartridge is spaced from the inner side surface of the pressure-proof vessel, then, the pressure of the pressure-proof vessel is reduced, the pressure-proof vessel is heated at the temperature of 230° C. or higher under a pressure reduced state, then, hydrogen gas is introduced to the pressure-proof vessel, and the pressure-proof vessel is sealed and held for a prescribed time.

30. The method for producing a hydrogen storage material according to claim 29, wherein the pressure-proof vessel is heated at the temperature of 400° C. to 800° C.

31. The method for producing a hydrogen storage material according to claim 1, wherein the carbonaceous material is formed by a carbonaceous material having a large surface area and a structural curvature.

32. The method for producing a hydrogen storage material according to claim 31, wherein the carbonaceous material is composed of a carbonaceous material selected from a group including fullerene, carbon nanofiber, carbon nanotube, carbon soot, nanocapsule, bucky onion and carbon fiber.

33. A hydrogen storing and desorbing apparatus comprising:
a pressure-proof vessel;
a cartridge whose outside diameter is smaller than the inside diameter of the pressure-proof vessel and whose outer peripheral wall part and bottom wall part are made of a porous material and which can accommodate a carbonaceous material therein;
holding means for holding the cartridge in the pressure-proof vessel so that the bottom wall part of the cartridge is spaced from the bottom surface of the pressure-proof vessel and the outer peripheral wall part is spaced from the inner side surface of the pressure-proof vessel;
gas passages connected to the pressure-proof vessel;
valves provided in the gas passages and
a hydrogen gas supply source connected to the pressure-proof vessel by the gas passage.

34. The hydrogen storing and desorbing apparatus according to claim 33, wherein the cross-section of the cartridge is annular shape and the inner peripheral wall part of the cartridge is formed of a porous material.

35. The hydrogen storing and desorbing apparatus according to claim 33, wherein the apparatus further comprises a heating means for heating the pressure-proof vessel.

36. The hydrogen storing and desorbing apparatus according to claim 33, wherein a first selector valve and a second selector valve are provided in the gas passages, the hydrogen gas supply source is connected to the gas passage through the first selector valve, and further, an inert gas supply source connected to the gas passage through the second selector valve is provided.

37. The hydrogen storing and desorbing apparatus according to claim 33, wherein a third selector valve is further provided in the gas passage and a reducing gas supply source is connected to the gas passage through the third selector valve.

38. The hydrogen storing and desorbing apparatus according to claim 33, wherein the holding means are composed of at least three leg parts provided on the outer surface of the bottom wall part of the cartridge.

39. The hydrogen storing and desorbing apparatus according to claim 33, wherein the holding means are composed of one or two or more of plate type leg members provided on the outer surface of the bottom wall part of the cartridge.

40. The hydrogen storing and desorbing apparatus according to claim 39, wherein the one or two or more of plate type leg members are formed of a porous material.

41. The hydrogen storing and desorbing apparatus according to claim 33, wherein the holding means comprise at least two protruding parts provided on the outer wall part of the cartridge and engagement protruding parts provided on the inner surface of the pressure-proof vessel and capable of engaging with the at least two protruding parts.
